(19) United States
(12) Patent Application Publication
(10) Pub. No.: US 2024/0322135 A1
(43) Pub. Date: Sep. 26, 2024

(54) NONAQUEOUS ELECTROLYTE SECONDARY BATTERY

(71) Applicant: Prime Planet Energy & Solutions, Inc., Tokyo (JP)

(72) Inventors: Yohei SHINDO, Toyota-shi (JP); Atsushi MATSUSHIMA, Toyota-shi (JP)

(21) Appl. No.: 18/611,623

(22) Filed: Mar. 20, 2024

(30) Foreign Application Priority Data
Mar. 24, 2023 (JP) 2023-048797

(51) Int. Cl. H01M 4/36; H01M 4/02; H01M 4/525; H01M 4/58

(52) U.S. Cl. CPC H01M 4/366; H01M 4/525; H01M 4/5825; H01M 2004/028

(57) ABSTRACT

Provided is a nonaqueous electrolyte secondary battery capable of suppressing resistance increase in long-term storage at high temperatures. A nonaqueous electrolyte secondary battery disclosed here includes a positive electrode, a negative electrode, and a nonaqueous electrolyte. The positive electrode includes a positive electrode current collector, and a positive electrode active material layer supported by the positive electrode current collector. The positive electrode active material layer includes a positive electrode active material, and at least one positive electrode additive selected from the group consisting a thiophosphate salt and a dithiophosphate salt.

### TECHNICAL FIELD

The present disclosure relates to a nonaqueous electrolyte secondary battery. This application claims the benefit of priority to Japanese Patent Application No. 2023-048797 filed on Mar. 24, 2023. The entire contents of this application are hereby incorporated herein by reference.

### BACKGROUND

Recent nonaqueous electrolyte secondary batteries such as lithium ion secondary batteries are suitably used for portable power supplies for devices such as personal computers and portable terminals, vehicle driving power supplies for vehicles such as battery electric vehicles (BEVs), hybrid electric vehicles (HEVs), and plug-in hybrid electric vehicles (PHEVs), and so forth.

A positive electrode of a nonaqueous electrolyte secondary battery typically includes a positive electrode active material layer containing a positive electrode active material. To enhance performance of such a nonaqueous electrolyte secondary battery, in a known technique, an additive for forming a coating on a surface of a positive electrode active material is allowed to be included in a positive electrode active material layer. Patent Document 1, for example, describes enhancement of cycle characteristics of a nonaqueous electrolyte secondary battery by including thiophosphate ester or thiophosphate ester salt in a positive electrode active material layer. Patent Document 2, for example, describes enhancement of output characteristics and cycle characteristics of a nonaqueous electrolyte secondary battery in the case of using a high-potential positive electrode active material by including lithium phosphate in a positive electrode active material layer.

### CITATION LIST

### Patent Documents

Patent Document 1: Japanese Patent Application Publication No. 2002-352804
Patent Document 2: Japanese Patent Application Publication No. 2016-062644

### SUMMARY

Through an intensive study, however, inventors of the present disclosure have found that the conventional techniques described above leave room for improvement in high-temperature storage characteristics of nonaqueous electrolyte secondary batteries, specifically, room for improvement in suppressing resistance increase in long-term storage of the nonaqueous electrolyte secondary batteries at high temperatures.

Embodiments of the present disclosure provide a nonaqueous electrolyte secondary battery capable of suppressing resistance increase in long-term storage at high temperatures.

A nonaqueous electrolyte secondary battery disclosed here includes a positive electrode, a negative electrode, and a nonaqueous electrolyte. The positive electrode includes a positive electrode current collector, and a positive electrode active material layer supported by the positive electrode current collector. The positive electrode active material layer includes a positive electrode active material, and at least one positive electrode additive selected from the group consisting of a thiophosphate salt and a dithiophosphate salt.

This configuration provides a nonaqueous electrolyte secondary battery capable of suppressing resistance increase in long-term storage at high temperatures.

### BRIEF DESCRIPTION OF THE DRAWINGS

FIG. 1 is a cross-sectional view schematically illustrating an internal structure of a lithium ion secondary battery according to one embodiment of the present disclosure.

FIG. 2 is a schematic disassembled view illustrating a structure of a wound electrode body of a lithium ion secondary battery according to one embodiment of the present disclosure.

### DETAILED DESCRIPTION

An embodiment of the present disclosure will be described hereinafter with reference to the drawings. Matters not specifically mentioned herein but required for carrying out the present disclosure can be understood as matters of design of a person skilled in the art based on related art in the field. The present disclosure can be carried out on the basis of the contents disclosed in the description and common general knowledge in the field. In the drawings, members and parts having the same functions are denoted by the same reference characters for description. Dimensional relationships (e.g., length, width, and thickness) in the drawings do not reflect actual dimensional relationships. A numerical range expressed as “A to B” herein includes A and B.

A “secondary battery” herein refers to an electricity storage device capable of being repeatedly charged and discharged, and includes a so-called storage battery and an electricity storage element such as an electric double layer capacitor. A “lithium ion secondary battery” herein refers to a secondary battery that uses lithium ions as charge carriers and performs charge and discharge by movement of charges accompanying lithium ions between positive and negative electrodes.

The present disclosure will be described in detail hereinafter using a flat square lithium ion secondary battery including a flat wound electrode body and a flat battery case as an example, but the present disclosure is not intended to be limited to the embodiment.

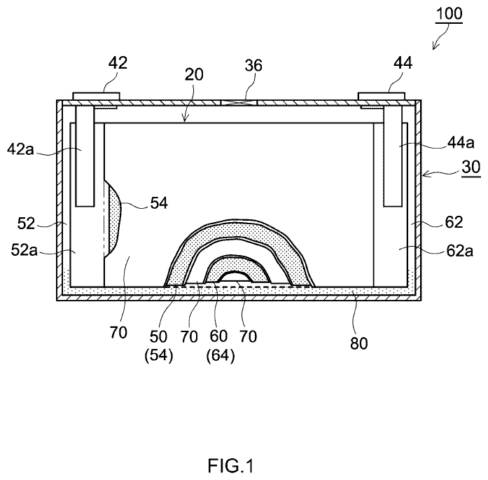

A lithium ion secondary battery 100 illustrated in FIG. 1 is a sealed battery in which a flat wound electrode body 20 and a nonaqueous electrolyte 80 are housed in a flat square battery case (i.e., an outer container) 30. The battery case 30 includes a positive electrode terminal 42 and a negative electrode terminal 44 for external connection, and a thin safety valve 36 configured such that when the internal pressure of the battery case 30 increases to a predetermined level or more, the safety valve 36 releases the internal pressure. The battery case 30 has an injection port (not shown) for injecting the nonaqueous electrolyte 80. The positive electrode terminal 42 is electrically connected to a positive electrode current collector plate 42a. The negative electrode terminal 44 is electrically connected to a negative electrode current collector plate 44a. A material for the battery case 30 is, for example, a metal material that is lightweight and has high thermal conductivity, such as aluminum. It should be noted that FIG. 1 does not strictly illustrate the amount of the nonaqueous electrolyte 80.

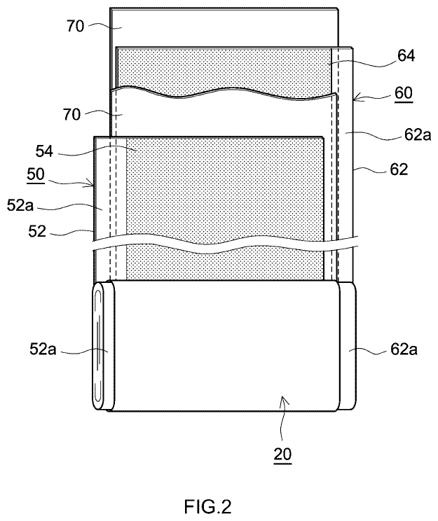

As illustrated in FIGS. 1 and 2, in the wound electrode body 20, a positive electrode sheet 50 and a negative electrode sheet 60 are stacked with two long separator sheets 70 interposed therebetween and are wound in the longitudinal direction. In the positive electrode sheet 50, a positive electrode active material layer 54 is formed on one or each (each in this example) surface of a long positive electrode current collector 52 along the longitudinal direction. In the negative electrode sheet 60, a negative electrode active material layer 64 is formed on one or each (each in this example) surface of a long negative electrode current collector 62 along the longitudinal direction. A positive electrode active material layer non-formed portion 52a (i.e., a portion where no positive electrode active material layer 54 is formed and the positive electrode current collector 52 is exposed) and a negative electrode active material layer non-formed portion 62a (i.e., a portion where no negative electrode active material layer 64 is formed and the negative electrode current collector 62 is exposed) extend off outward from both ends of the wound electrode body 20 in the winding axis direction (i.e., sheet width direction orthogonal to the longitudinal direction). The positive electrode current collector plate 42a and the negative electrode current collector plate 44a are respectively joined to the positive electrode active material layer non-formed portion 52a and the negative electrode active material layer non-formed portion 62a.

The positive electrode current collector 52 constituting the positive electrode sheet 50 may be a known positive electrode current collector for use in a lithium ion secondary battery, and examples of the positive electrode current collector 52 include sheets or foil of highly conductive metals (e.g., aluminum, nickel, titanium, and stainless steel). The positive electrode current collector 52 is desirably aluminum foil.

Dimensions of the positive electrode current collector 52 are not particularly limited, and may be appropriately determined depending on battery design. In the case of using aluminium foil as the positive electrode current collector 52, the thickness thereof is not particularly limited, and is, for example, 5 μm or more and 35 μm or less, desirably 7 μm or more and 20 μm or less.

The positive electrode active material layer 54 includes a positive electrode active material, and at least one positive electrode additive selected from the group consisting of a thiophosphate salt and a dithiophosphate salt. The positive electrode active material may be a known positive electrode active material to be used in a lithium ion secondary battery. Specifically, for example, as the positive electrode active material, a material such as a lithium composite oxide or a lithium transition metal phosphate compound may be used. The crystal structure of the positive electrode active material is not particularly limited, and may be, for example, a layered structure, a spinel structure, or an olivine structure.

The lithium composite oxide is desirably a lithium transition metal composite oxide including at least one of Ni, Co, or Mn as a transition metal element, and specific examples of the lithium transition metal composite oxide include a lithium nickel composite oxide, a lithium cobalt composite oxide, a lithium manganese composite oxide, a lithium nickel manganese composite oxide, a lithium nickel cobalt manganese composite oxide, a lithium nickel cobalt aluminum composite oxide, and a lithium iron nickel manganese composite oxide.

It should be noted that the “lithium nickel cobalt manganese composite oxide” herein includes not only oxides including Li, Ni, Co, Mn, and O as constituent elements, but also an oxide further including one or more additive elements besides them. Examples of the additive elements include transition metal elements and typical metal elements such as Mg, Ca, Al, Ti, V, Cr, Y, Zr, Nb, Mo, Hf, Ta, W, Na, Fe, Zn, and Sn. The additive element may be a metalloid element such as B, C, Si, or P, and a nonmetal element such as S, F, Cl, Br, or I. This also applies, in the same manner, to, for example, the lithium nickel composite oxide, the lithium cobalt composite oxide, the lithium manganese composite oxide, the lithium nickel manganese composite oxide, the lithium nickel cobalt aluminium composite oxide, and the lithium iron nickel manganese composite oxide described above.

Examples of the lithium transition metal phosphate compound include lithium iron phosphate (LiFePO₄), lithium manganese phosphate (LiMnPO₄), and lithium manganese iron phosphate.

These positive electrode active materials can be used alone or two or more of them may be used in combination.

By subjecting the lithium ion secondary battery 100 to initial charge, the positive electrode additive is decomposed and a coating derived from the positive electrode additive is formed on the surface of the positive electrode active material. This initial charge is generally performed at a voltage greater than or equal to a decomposition start potential of the positive electrode additive. However, it is sufficient to apply a voltage greater than or equal to the decomposition start potential of the positive electrode additive only in the initial charge, and thus, an upper limit potential of the positive electrode active material in a general mode of use of a lithium ion secondary battery may be lower than the decomposition start potential of the positive electrode additive.

From the viewpoint of battery characteristics and stability of the crystal structure in initial charge, the positive electrode active material is desirably a lithium composite oxide having a layered structure. The lithium composite oxide desirably contains Ni. Thus, the positive electrode active material is desirably a lithium nickel cobalt manganese composite oxide and a lithium nickel cobalt aluminum composite oxide, more desirably a lithium nickel cobalt manganese composite oxide.

A ratio of Ni to all metal elements except for Li in the lithium composite oxide is desirably 20% by mole to 60% by mole, more desirably 30% by mole to 50% by mole.

An average particle size (median particle size: D50) of the positive electrode active material is not particularly limited, and is, for example, 0.05 μm or more and 25 μm or less, desirably 1 μm or more and 20 μm or less, more desirably 3 μm or more and 15 μm or less. It should be noted that the average particle size (D50) of the positive electrode active material can be determined by, for example, a laser diffraction/scattering method.

A content of the positive electrode active material in the positive electrode active material layer 54 (i.e., content of the positive electrode active material with respect to a total mass of the positive electrode active material layer 54) is not particularly limited, and is, for example, 80% by mass or more, desirably 85% by mass or more, more desirably 87% by mass or more.

The positive electrode additive is a component that forms a coating on the surface of the positive electrode active material when the lithium ion secondary battery 100 is subjected to initial charge. In this embodiment, as the positive electrode additive, at least one compound selected from the group consisting of a thiophosphate salt and a dithiophosphate salt.

The thiophosphate salt is a salt of a thiophosphate anion represented by Formula (1) below and a cation(s). The dithiophosphate salt is a salt of a dithiophosphate anion represented by Formula (2) below and a cation(s). The thiophosphate salt and the dithiophosphate salt are typically inorganic salts, and thus, typically include no organic groups. Each of the thiophosphate anion and the dithiophosphate anion is a trivalent anion, and a cation(s) is a univalent, divalent, or trivalent cation (especially a metal cation).

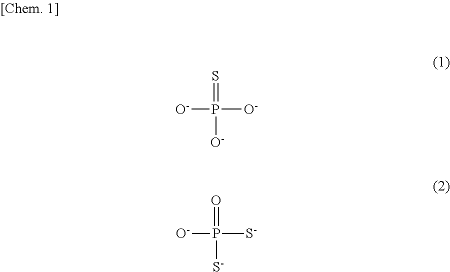 [SMILES: [O-]P([O-])([O-])=S ; O=P([O-])([S-])[S-]]

Since the thiophosphate anion and the dithiophosphate anion greatly contribute to formation of the coating, the type of the cation is not particularly limited. Examples of the cation include an alkali metal cation such as Li⁺, Na⁺, and K⁺; an alkali earth metal cation such as Mg²⁺, Ca²⁺, Sr²⁺, and Ba²⁺; a Group 12 element cation such as Zn²⁺; and a Group 13 element cation such as Al³⁺. Among these cations, an alkali metal cation is desirable.

From the viewpoint of easy availability, sodium thiophosphate is especially desirable as the thiophosphate salt. Similarly, from the viewpoint of easy availability, sodium dithiophosphate is especially desirable as the dithiophosphate salt. From the viewpoint of battery performance, lithium thiophosphate is especially desirable as the thiophosphate salt. Similarly, from the viewpoint of battery performance, lithium dithiophosphate is especially desirable as the dithiophosphate salt.

From the viewpoint of lower initial resistance and more excellent high-temperature storage characteristics, as the positive electrode additive, the dithiophosphate salt is desirable, and an alkali metal salt of dithiophosphoric acid is more desirable.

The thiophosphate salt and the dithiophosphate salt have relatively lower decomposition start potentials as positive electrode additives. For example, the decomposition start potential of Li₃PO₃ is 4.50V (vsLi⁺/Li), whereas the decomposition start potential of sodium thiophosphate (Na₃PSO₃) is 4.35V (vsLi⁺/Li), and the decomposition start potential of sodium dithiophosphate (Na₃PS₂O₂) is 4.25V (vsLi⁺/Li). Thus, in initial charge of the lithium ion secondary battery 100, these positive electrode additives can be efficiently decomposed, and a high-quality coating can be formed on the surface of the positive electrode active material layer. As a result, it is possible to suppress resistance increase occurring when the lithium ion secondary battery 100 is subjected to long-term storage at high temperatures.

As the content of the positive electrode additive in the positive electrode active material layer 54 increases, the effect of suppressing resistance increase when the lithium ion secondary battery 100 is subjected to long-term storage at high temperatures increases. In view of this, the content of the positive electrode additive in the positive electrode active material layer 54 (i.e., mass ratio of the positive electrode additive with respect to the total mass of all the components of the positive electrode active material layer) is desirably 0.1% by mass or more, more desirably 0.5% by mass or more, even more desirably 1% by mass or more. On the other hand, when the content of the positive electrode additive is large, the initial resistance tends to increase. Thus, the content of the positive electrode additive in the positive electrode active material layer 54 is desirably 15% by mass or less, more desirably 10% by mass or less, even more desirably 5% by mass or less.

The positive electrode active material layer 54 may include only at least one compound selected from the group consisting of the thiophosphate salt and the dithiophosphate salt as a positive electrode additive, or may further include another positive electrode additive within a range that does not significantly inhibit the effects of the present invention.

The positive electrode active material layer 54 may include a component other than the positive electrode active material and the positive electrode additive (i.e., may include an optional component). Examples of the optional component include a conductive agent and a binder. Desired examples of the conductive agent include a carbon material such as carbon black (e.g., acetylene black), carbon nanotubes (CNTs), and graphite. Examples of the binder include polyvinylidene fluoride (PVDF). In the case of using CNTs as the conductive agent, the positive electrode active material layer 54 may further include a disperser of CNTs.

A content of the conductive agent in the positive electrode active material layer 54 is not particularly limited, and is desirably 0.1% by mass or more and 15% by mass or less, more desirably 0.5% by mass or more and 13% by mass or less. A content of the binder in the positive electrode active material layer 54 is not particularly limited, and is desirably 1% by mass or more and 15% by mass or less, more desirably 1.5% by mass or more and 10% by mass or less.

A thickness of the positive electrode active material layer 54 is not particularly limited, and is, for example, 10 μm or more and 300 μm or less, desirably 20 μm or more and 200 μm or less.

The positive electrode sheet 50 may include an insulating layer (not shown) at the boundary between the positive electrode active material layer non-formed portion 52a and the positive electrode active material layer 54. The insulating layer contains ceramic particles, and the like.

As the negative electrode current collector 62 constituting the negative electrode sheet 60, a known negative electrode current collector for use in a lithium ion secondary battery may be used, and examples of the negative electrode current collector include sheets or foil of highly conductive metals (e.g., copper, nickel, titanium, and stainless steel). The negative electrode current collector 62 is desirably copper foil.

Dimensions of the negative electrode current collector 62 are not particularly limited, and may be appropriately determined depending on battery design. In the case of using copper foil as the negative electrode current collector 62, the thickness thereof is not particularly limited, and is, for example, 5 μm or more and 35 μm or less, desirably 7 μm or more and 20 μm or less.

The negative electrode active material layer 64 contains a negative electrode active material. Examples of the negative electrode active material include carbon materials such as graphite, hard carbon, and soft carbon. Graphite may be natural graphite or artificial graphite, and may be amorphous carbon-coated graphite in which graphite is coated with an amorphous carbon material.

The average particle size (median particle size: D50) of the negative electrode active material is not particularly limited, and is, for example, 0.1 μm or more and 50 μm or less, desirably 1 μm or more and 25 μm or less, and more desirably 5 μm or more and 20 μm or less. It should be noted that the average particle size (D50) of the negative electrode active material can be determined by, for example, a laser diffraction/scattering method.

The negative electrode active material layer 64 can include components other than the active material, such as a binder or a thickener. Examples of the binder include styrene-butadiene rubber (SBR) and polyvinylidene fluoride (PVDF). Examples of the thickener include carboxymethyl cellulose (CMC).

A content of the negative electrode active material in the negative electrode active material layer 64 is desirably 90% by mass or more, more desirably 95% by mass or more and 99% by mass or less. A content of the binder in the negative electrode active material layer 64 is desirably 0.1% by mass or more and 8% by mass or less, more desirably 0.5% by mass or more and 3% by mass or less. A content of the thickener in the negative electrode active material layer 64 is desirably 0.3% by mass or more and 3% by mass or less, more desirably 0.5% by mass or more and 2% by mass or less.

The thickness of the negative electrode active material layer 64 is not particularly limited, and is, for example, 10 μm or more and 300 μm or less, desirably 20 μm or more and 200 μm or less.

Examples of the separators 70 include a porous sheet (film) of a resin such as polyethylene (PE), polypropylene (PP), polyester, cellulose, or polyamide. The porous sheet may have a single-layer structure or a laminated structure of two or more layers (e.g., three-layer structure in which PP layers are stacked on both surfaces of a PE layer). A heat-resistance layer (HRL) may be provided on a surface of each separator 70.

A thickness of each separator 70 is not particularly limited, and is, for example, 5 μm or more and 50 μm or less, desirably 10 μm or more and 30 μm or less. An air permeability of each separator 70 obtained by a Gurley permeability test is not particularly limited, and is desirably 350 sec./100 cc or less.

A nonaqueous electrolyte 80 typically includes a nonaqueous solvent and a supporting electrolyte (electrolyte salt). As the nonaqueous solvent, various organic solvents such as carbonates, ethers, esters, nitriles, sulfones, and lactones for use in an electrolyte of a typical lithium ion secondary battery can be used without any particular limitation. Among these, carbonates and esters are desirable, and specific examples of the carbonates and the esters include ethylene carbonate (EC), propylene carbonate (PC), diethyl carbonate (DEC), dimethyl carbonate (DMC), ethyl methyl carbonate (EMC), monofluoroethylene carbonate (MFEC), difluoroethylene carbonate (DFEC), monofluoromethyl difluoromethyl carbonate (F-DMC), trifluorodimethyl carbonate (TFDMC), methyl acetate, and methyl propionate. Such nonaqueous solvents may be used alone or two or more of them may be used in combination.

Desired examples of the supporting electrolyte include lithium salts such as LiPF₆, LiBF₄, and lithium bis(fluorosulfonyl)imide (LiFSI) (desirably LiPF₆). A concentration of the supporting electrolyte is desirably 0.7 mol/L or more and 1.3 mol/L or less.

The nonaqueous electrolyte 80 may include components not described above, for example, various additives exemplified by: a film forming agent such as vinylene carbonate (VC) or an oxalato complex; a gas generating agent such as biphenyl (BP) or cyclohexylbenzene (CHB); and a thickener, to the extent that the effects of the present disclosure are not significantly impaired.

When the thus-configured lithium ion secondary battery 100 is subjected to initial charge to a voltage greater than or equal to the decomposition start potential of the positive electrode additive, resistance increase in long-term storage at high temperatures can be suppressed. Thus, the configuration described above provides the lithium ion secondary battery 100 with high durability.

The lithium ion secondary battery 100 is applicable to various applications. Specific examples of application of the lithium ion secondary battery 100 include: portable power supplies for personal computers, portable electronic devices, portable terminals, and the like; vehicle driving power supplies for vehicles such as electric vehicles (BEVs), hybrid electric vehicles (HEVs), and plug-in hybrid electric vehicles (PHEVs); and storage batteries for small power storage devices, and among these, vehicle driving power supplies are especially desirable. The lithium ion secondary battery 100 can be used in a battery module in which a plurality of batteries are typically connected in series and/or in parallel.

The foregoing description is directed to the square lithium ion secondary battery 100 including the flat wound electrode body 20 as an example. Alternatively, the lithium ion secondary battery can also be configured as a lithium ion secondary battery including a stacked-type electrode body (i.e., electrode body in which a plurality of positive electrodes and a plurality of negative electrodes are alternately stacked). The lithium ion secondary battery can also be configured as a cylindrical lithium ion secondary battery or a laminated-case lithium ion secondary battery.

The secondary battery according to this embodiment can be configured as a nonaqueous secondary battery other than a lithium ion secondary battery according to a known method.

Examples of the present disclosure will now be described in detail, but are not intended to limit the present disclosure to these examples.

[Examples 1 to 9 and Comparative Examples 1 to 4] First, LiNi_{0.5}Co_{0.2}Mn_{0.3}O₂ (NCM) as positive electrode active material powder, acetylene black (AB) as a conductive agent, and polyvinylidene fluoride (PVdF) as a binder were mixed at a mass ratio of NCM:AB:PVdF=90:5:5. Then, a positive electrode additive shown in Table 1 was added to the resulting mixture such that a content of the positive electrode additive in a positive electrode active material layer was the amount shown in Table 1, and the resulting mixture was further mixed with N-methylpyrrolidone (NMP). In this manner, slurry for forming a positive electrode active material layer was prepared. This slurry was applied onto each surface of aluminum foil and then dried, thereby forming a positive electrode active material layer. A total weight per unit area at both surfaces at this time was 15 mg/cm². Thereafter, the positive electrode active material layer was subjected to a rolling press treatment to have a density of 2.5 g/cm³, thereby obtaining a positive electrode sheet.

Natural graphite (C) as a negative electrode active material, styrene-butadiene rubber (SBR) as a binder, and carboxymethyl cellulose (CMC) as a thickener were mixed with ion-exchanged water at a mass ratio of C:SBR:CMC=97:2:1, thereby preparing slurry for forming a negative electrode active material layer. This slurry was applied onto each surface of copper foil and then dried, thereby forming a negative electrode active material layer. A total weight per unit area at both surfaces at this time was 9 mg/cm². Subsequently, the negative electrode active material layer was subjected to a rolling press treatment to have a density of 1.2 g/cm³, thereby obtaining a negative electrode sheet.

As a separator, a polyolefin porous film was prepared. The obtained positive electrode sheet and negative electrode sheet were stacked with the separator interposed therebetween, thereby forming a stacked electrode body. Terminals were attached to the electrode body, and the electrode body was housed in an aluminum battery case.

A mixed solvent including ethylene carbonate (EC), dimethyl carbonate (DMC), and ethyl methyl carbonate (EMC) at a volume ratio of 25:40:35 was prepared. In this mixed solvent, LiPF₆ was dissolved at a concentration of 1.1 mol/L, thereby preparing a nonaqueous electrolyte. The prepared nonaqueous electrolyte was injected into the battery case, and the battery case was sealed, thereby preparing an evaluation lithium ion secondary battery of each of examples and comparative examples.

### <Activation Treatment>

Each of the thus-fabricated evaluation lithium ion secondary batteries was placed in a thermostat at 25° C. Each evaluation lithium ion secondary battery was charged with a constant current to a predetermined upper limit voltage at a current value of 0.1 C, and then discharged with a constant current to 3.0 V. This predetermined upper limit voltage was a voltage at which a positive electrode potential (vsLi⁺/Li) was shown in Table 1. This charge and discharge process was performed twice. Then, each evaluation lithium ion secondary battery was adjusted to a voltage of 3.7 V, and then placed in a thermostat at 60° C. to be subjected to an aging treatment for 12 hours. In the manner described above, the activation treatment was performed on the evaluation lithium ion secondary batteries according to the examples and the comparative examples.

### <Initial Characteristic Evaluation>

Each evaluation lithium ion secondary battery activated as described above was charged with a constant current at a current value of 0.1 C to the predetermined upper limit voltage, and then discharged with a constant current to 3.0 V. A discharge capacity at this time was measured and defined as an initial capacity.

This initial capacity was defined as an SOC of 100%, and each evaluation lithium ion secondary battery was adjusted at 25° C. to have an SOC of 50%. Thereafter, each evaluation lithium ion secondary battery was placed in a thermostat at −10° C., and discharged for 10 seconds at a current value of 10 C. A voltage change amount ΔV at this time was measured, and using this voltage change amount ΔV and the current value, an output resistance of each evaluation lithium ion secondary battery was calculated as an initial resistance. Table 1 shows the results.

### <High-Temperature Storage Characteristic Evaluation>

Each evaluation lithium ion secondary battery activated as described above was adjusted to have an SOC of 80% under a temperature environment of 25° C. Each evaluation lithium ion secondary battery was placed in a thermostat at 60° C., and stored for 60 days. Thereafter, with the same method as the initial resistance, an output resistance after storage was measured. From Expression: (output resistance after high-temperature storage/initial resistance)×100, a resistance increase rate (%) was obtained. Table 1 shows the results.

TABLE 1

| | | | Positive | | |
|---|---|---|---|---|---|
| | | | electrode | Battery performance | |
| | Positive electrode additive | | potential at | | Resistance |
| | | Amount of | upper limit | Initial | increate rate |
| | | addition | voltage | resistance | after storage |
| | Type | (mass %) | (VvsLi⁺/Li) | (mΩ) | (%) |
| Example 1 | Na₃PSO₃ | 1 | 4.35 | 10.1 | 112 |
| Example 2 | Na₃PSO₃ | 3 | 4.35 | 10.4 | 110 |
| Example 3 | Na₃PSO₃ | 5 | 4.35 | 10.9 | 109 |
| Example 4 | Na₃PSO₃ | 10 | 4.35 | 11.6 | 108 |
| Example 5 | Na₃PS₂O₂ | 1 | 4.3 | 9.7 | 107 |
| Example 6 | Na₃PS₂O₂ | 3 | 4.3 | 10.0 | 105 |
| Example 7 | Na₃PS₂O₂ | 5 | 4.3 | 10.4 | 104 |
| Example 8 | Na₃PS₂O₂ | 10 | 4.3 | 11.0 | 103 |
| Example 9 | Na₃PS₂O₂ | 3 | 4.35 | 10.5 | 107 |
| Comparative Example 1 | none | 0 | 4.35 | 9.4 | 129 |
| Comparative Example 2 | Li₃PO₄ | 3 | 4.35 | 10.2 | 123 |
| Comparative Example 3 | Li₂CO₃ | 3 | 4.35 | 10.4 | 131 |
| Comparative Example 4 | trimethyl thiophosphate | 3 | 4.2 | 10.3 | 127 |

As shown in Table 1, in Examples 1 to 9, a thiophosphate salt and a dithiophosphate salt were used as positive electrode additives. In Comparative Example 1, no positive electrode additive was used. In Comparative Example 2, Li₃PO₄, used in a conventional technique, was used as a positive electrode additive. In Comparative Example 3, Li₂CO₃ was used as a positive electrode additive. In Comparative Example 4, trimethyl phosphate, which is a thiophosphate ester in a conventional technique, was used as a positive electrode additive.

As shown in results of Table 1, Examples 1 to 9 show significantly smaller degrees of resistance increase after high-temperature storage than those in Comparative Examples 1 to 4. Thus, it can be understood that in the nonaqueous electrolyte secondary battery disclosed here, resistance increase after long-term storage at high temperatures can be suppressed.

Specific examples of the present disclosure have been described in detail hereinbefore, but are merely illustrative examples, and are not intended to limit the scope of claims. The techniques described in claims include various modifications and changes of the above exemplified specific examples.

That is, the nonaqueous electrolyte secondary battery disclosed here is the following items [1] to [5].
[1] A nonaqueous electrolyte secondary battery including:
   a positive electrode;
   a negative electrode; and
   a nonaqueous electrolyte, wherein
   the positive electrode includes a positive electrode current collector, and a positive electrode active material layer supported by the positive electrode current collector, and
   the positive electrode active material layer includes a positive electrode active material, and at least one positive electrode additive selected from the group consisting of a thiophosphate salt and a dithiophosphate salt.
[2] The nonaqueous electrolyte secondary battery of item [1] in which a content of the positive electrode additive in the positive electrode active material layer is 1% by mass to 10% by mass.
[3] The nonaqueous electrolyte secondary battery of item [1] or [2] in which a content of the positive electrode additive in the positive electrode active material layer is 1% by mass to 5% by mass.
[4] The nonaqueous electrolyte secondary battery of any one of items [1] to [3] in which
   the positive electrode active material is a lithium composite oxide with a layered structure, and
   the lithium composite oxide contains Ni.
[5] The nonaqueous electrolyte secondary battery of any one of items [1] to [4] in which the positive electrode additive is an alkali metal salt of dithiophosphoric acid.

What is claimed is:

1. A nonaqueous electrolyte secondary battery comprising:
a positive electrode;
a negative electrode; and
a nonaqueous electrolyte, wherein
the positive electrode includes a positive electrode current collector, and a positive electrode active material layer supported by the positive electrode current collector, and
the positive electrode active material layer includes a positive electrode active material, and at least one positive electrode additive selected from the group consisting of a thiophosphate salt and a dithiophosphate salt.

2. The nonaqueous electrolyte secondary battery according to claim 1, wherein a content of the positive electrode additive in the positive electrode active material layer is 1% by mass to 10% by mass.

3. The nonaqueous electrolyte secondary battery according to claim 1, wherein a content of the positive electrode additive in the positive electrode active material layer is 1% by mass to 5% by mass.

4. The nonaqueous electrolyte secondary battery according to claim 1, wherein
the positive electrode active material is a lithium composite oxide with a layered structure, and
the lithium composite oxide contains Ni.

5. The nonaqueous electrolyte secondary battery according to claim 1, wherein the positive electrode additive is an alkali metal salt of dithiophosphoric acid.
